(19) United States
(12) Patent Application Publication
(10) Pub. No.: US 2003/0036814 A1
(43) Pub. Date: Feb. 20, 2003

(54) Slalom water-ski training and monitoring system for on-water use

(76) Inventor: Paul Lawrence Middleton, Plymouth, MN (US)

Correspondence Address: PAUL L. MIDDLETON, 10707 32nd Ave N, PLYMOUTH, MN, 55441, US

(21) Appl. No.: 09/928,880

(22) Filed: Aug. 14, 2001

(51) Int. Cl. G06F 155/00

(52) U.S. Cl. 700/91

(57) ABSTRACT

An apparatus for measuring the performance of a slalom water-skier and associated methods for interpretation of the data are disclosed. The apparatus consists of a means for measuring the angle of the water-ski tow rope relative to the boat and the tension of the water-ski tow rope. This data may be transmitted immediately or stored for later transmittal. The data are analyzed by calculating the time spent in the various regions of the slalom course, or by calculating how early or late the skier is for the individual buoys in the course.

### BACKGROUND OF THE INVENTION

This invention relates to the sport of slalom water-skiing, and more specifically for training and monitoring systems relating to said sport.

A variety of water-ski training devices have been proposed in the past. For example, U.S. Pat. No. 4,669,993 describes a method of adjusting a water-ski to enable easier use by beginners. U.S. Pat. No. 5,911,611 describes a device to enable beginners to more easily get out of the water. These inventions relate primarily to beginning skiers, and are not useful to intermediate or advanced skiers.

For those beyond the beginner stage, U.S. Pat. No. 5,342,266 describes a dry-land device to teach proper body positioning and to allow for muscle toning. While this may be a very helpful device, it is of no use to the skier when training on the water.

Current on-water slalom water-ski training techniques include the use of subjective expert judgment of water-ski trainers, observing skiers proceeding through a regulation slalom course. Current on-water slalom water-ski monitoring techniques include the use of video taping systems.

Slalom water-ski training, in the current state of the art, is of limited efficacy without a slalom course, that is, a set of buoys fixed in a set pattern in the water. However, a slalom course is costly, and setting the course up is time-consuming and may be prohibited on certain lakes.

Objective measures of slalom water-skiing success are today limited mainly to the success or failure to round each buoy. Expert trainers can determine much by observing the skier progress through the slalom course, but this knowledge is difficult to pass on. Spectator viewing of slalom water-skiing events, for those who are not experts themselves, is limited to observing whether or not the buoy was rounded. As competition becomes more intense, it is difficult to determine in which segment of the course a skier may need to improve in order to reach top performance.

In “audio slalom” skiers with vision impairments utilize a system which emits sounds when the slalom tow rope reaches a certain, pre-established angle. This sound indicates to them that they have reached a distance from the boat which is sufficient to round a buoy. This system is used by disabled skiers for competition. It has been used to define a new sport which is a derivative of slalom water-skiing. This system is not a training and monitoring system for slalom water-skiing, and could not be used as such without the use of the present invention, as described below.

The present invention, as described in the following sections, satisfies some of the training and monitoring needs identified above.

### BRIEF SUMMARY OF THE INVENTION

Some of the shortcomings of the prior art are addressed in the present invention, which relates to an apparatus for monitoring slalom water-skiing and a method of processing the monitored information.

A slalom waterskier and boat are illustrated in FIG. 8. Slalom water-skiing is a sport wherein a water-skier 102, wearing a single ski 801, is towed behind a boat by a tow rope 105 attached to a pylon 300 mounted in the boat 103. The skier is towed through a slalom course as illustrated in FIG. 1. The boat 103 proceeds in a straight line through an arrangement of gate buoys 100 at fixed locations in the water. The object is for the skier 102, attached to the boat 103 via tow rope 105, to pass through an entrance gate of two buoys 106, then ski to the outside of six skier buoys 101 in a serpentine manner, and proceed through the final gate buoys 107. FIG. 1 shows the skiers path 104 passing through the entrance gate 106 and rounding 3 of the skier buoys 101. (Note that for ease of illustration, the course width is exaggerated in FIG. 1.) In slalom water-skiing competition, the boat speed is gradually increased on successive runs, and the tow rope length is decreased, until the skiers fail to negotiate the course, with the skier rounding the most buoys at the shortest tow rope length and highest boat speed declared the winner.

Slalom water-ski trainers distinguish between the techniques required of the skier in negotiating the various portions of the course, such as the wake crossing (i.e., the time when the skier is directly behind the boat and crossing the boat's wake), the pre-turn, the turn, and the acceleration. Each segment requires precise body positioning and balance to achieve the desired results. FIG. 2 illustrates these segments for one buoy of the slalom course. The skiers path is divided into segments by the horizontal lines 205 representing fixed distances from the center of the boat's path through the course. Each segment of the skiers path between the horizontal lines 205 is a different segment of the course. Segment 201 is referred to as the acceleration segment, 202 is referred to as the wake-crossing segment, as the skier is crossing the boat's wake in this segment. Segment 203 is referred to as the pre-turn segment, and segment 204 is referred to as the turn segment. Note that the order of these segments will be reversed as the skier travels in the other direction towards the next buoy, that is, the acceleration segment will always follow the turn segment. The exact location of the transitions between the segments is not precisely defined, and may vary for different line lengths and boat speeds.

As a slalom water-skier proceeds through a slalom course with proper technique, the tow rope remains in tension, and therefore describes an approximately straight line. Thus the angle of the tow rope to the boat centerline determines the location of the tow rope handle. The position of the tow rope handle can be used to infer the progress of the skier through the course. Thus by measurement of the tow rope angle, the skiers position can be determined. By correlating the tow rope angle measurement with the boat position in the slalom course, the skier's course performance can be accurately and repeatably measured.

Note that, due to variations in the amount of leaning that the skier may do at the peak of the turn, this method will not always be able to resolve success in rounding a buoy. However, buoy rounding is the only portion of the run that is obvious today to all observers. The present invention provides advantage to the users by providing precise information about portions of the course which is not available through use of the prior art.

The apparatus of the present invention gathers information about the angle of the skiers tow rope as the boat progresses through the slalom course. Optionally, the invention also gathers information about the tension in the tow rope as the boat progresses through the slalom course. The information about the angle of the tow rope, and the tension in the tow rope, coupled with information about the boat's progress through the slalom course, is processed in various manners to provide benefit to the user in several scenarios, detailed in the following paragraphs. These scenarios illustrate the features of novelty of the present invention which are not available in the prior art.

Open-Water Slalom Trainer

Beginning slalom skiers who wish to train for slalom course execution, but are without the benefit of a slalom course, may practice form and technique on the open water. However, they are hampered by lack of information about both the distance out to the side of the boat which is required, and the speed of traverse from one side of the boat to the other which is required. The present invention can remedy this situation by giving indication to the skier of both angular and timing success as the skier practices on the open water.

Slalom Trainer with Run Statistics

Slalom skiers who practice with slalom course setups strive to achieve ever higher boat speeds and shorter line lengths. A failure at the attempted level must be evaluated so that the skier can work to improve performance. However, it may be difficult to determine in what area the skier most needs improvement—it could be in the turn, it could be in the wake crossing, it could be in the acceleration. The present invention can objectively measure the skier's performance in each segment of the course, even recording several runs and establishing performance trends. This data can be used to determine where improvement is most needed for the skier to advance to the next level.

Slalom Trainer with Broadcast

Slalom spectators who are not water-ski experts can observe the skiers progress through the course, but have difficulty in spotting errors in technique which may be obvious to the experts. Through real-time updates on a skiers progress though the course, including each segment of each buoy, a television viewing audience may better grasp the performance of each competing skier, quickly pinpointing segments of success or error. In this way, the present invention may enhance enjoyment and appreciation of the sport.

These advantages and others are more fully described in the following detailed description of the invention.

### BRIEF DESCRIPTION OF THE SEVERAL VIEWS OF THE DRAWINGS

FIG. 1 is a top plan view of a slalom water-ski course on the water, illustrating the positioning of the buoys and the boat path. (Note that for ease of illustration, the course width is exaggerated in FIG. 1.)

FIG. 2 is a top plan view of the skier path through the slalom course, defining the slalom course segments in accord with the principles of the present invention.

FIG. 3 contains a top plan view of an angle measurement device generally in accordance with the principles of the present invention for measuring the angle of the slalom tow rope relative to the boat.

FIG. 4 contains a side elevation view of the angle measurement device of the type shown in FIG. 3.

FIG. 5 is a block diagram of an electronic controller of the type that may be utilized in the preferred embodiment of the present invention.

FIG. 6 is a perspective front elevational view of a housing for the electronic controller used in the preferred embodiment of the present invention.

FIG. 7 is a perspective front elevational view of a display generally in accordance with the principles of the present invention, comprised of two lamps and the associated bracket.

FIG. 8 is a side elevation view of a water-skier behind a boat, showing generally the relationship between the skier and the boat.

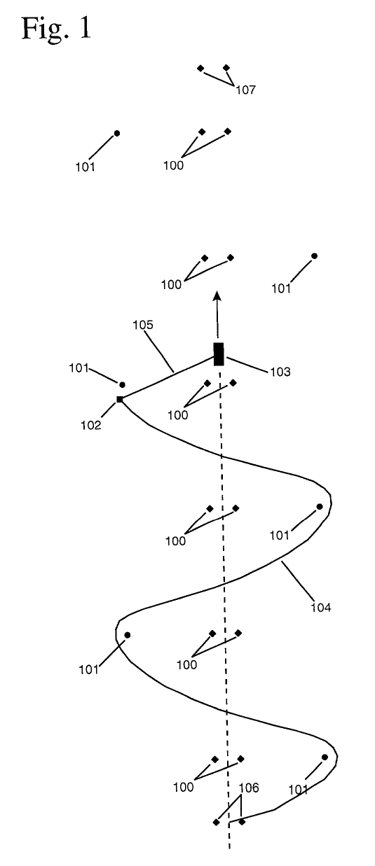

### DETAILED DESCRIPTION OF THE INVENTION

The water-ski performance measurement device of the present invention generally includes 4 functional blocks: an angle measurement device, a strain measurement device, a data processing device, and a data reporting device. Each is described in detail below, and illustrated in the accompanying figures.

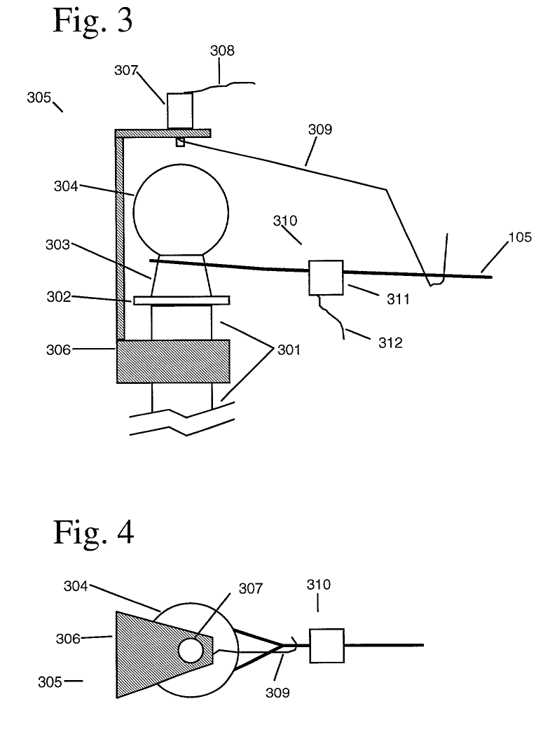

FIG. 3 and FIG. 4 illustrate the angle measurement device and the strain measurement device, each showing different views of the same devices. The water-ski tow rope 105 is normally connected to the boat at a pylon. This pylon is a vertical metal column 301, the base of which is securely fastened to the boat (not shown in figure). The top of the column is affixed with a collar 302, sleeve 303, and ball 304. Column 301, collar 302, sleeve 303, and ball 304 are collectively referred to as the pylon, which is typical of those used in water-skiing today. FIG. 3 shows the top plan view, while FIG. 4 shows the side elevation view of the top of the pylon, with angle measurement device and strain measurement device attached. Angle measurement device 305 consists of bracket 306, encoder 307, encoder harness 308, and clip 309. Bracket 306 is a metal bracket clamped at its base to column 301, with its upper section suspended over the top of ball 304. Bracket 306 provides a hole for mounting of encoder 307 such that the center of the encoder shaft is aligned with the center of the pylon 305. In the preferred embodiment, this encoder is an optical shaft encoder, of the type commonly used in electric motor control, having a minimum resolution of 0.5 degrees over a range of 180 degrees. This device converts its shaft angle into a series of electrical pulses suitable for interpretation by a digital computer. Alternately, a rotary potentiometer could be utilized in place of the optical shaft encoder, performing the same function. Encoder harness 308 sends electrical signals from encoder 307 to the data processing device to be described in later paragraphs. Clip 309 is a flexible steel wire attached at one end to the encoder shaft, and bent at the other end in such a manner as to cradle the slalom tow rope 105 and follow its angular motion. This will cause the angle of the encoder shaft to match the angle of the slalom tow rope. Optional strain measurement device 310 consists of strain gauge 311 and strain gauge harness 312. Strain gauge 311 is attached at both ends to the slalom tow rope such that the slalom tow rope force is transmitted through the strain gauge 311, allowing the strain gauge output to describe the tension in tow rope 105. Strain gauge harness 312 sends electrical signals from strain gauge 311 to the data processing device to be described in later paragraphs.

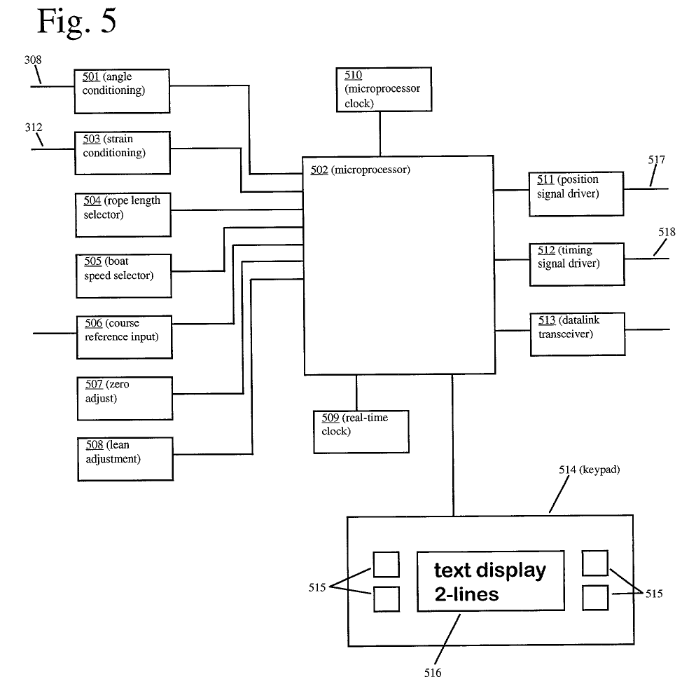

The data processing device is shown in block diagram form in FIG. 5. Note that the preferred embodiment utilizes a digital electronic microprocessor, while other embodiments of the present invention could utilize alternate methods. The data processing device utilizes several inputs which determine the interpretation of the signals from the angle measurement device and the strain measurement device described in FIG. 3. The data processing device contains input circuitry, microprocessor, and output circuitry. Note that numerous other features common to electronic controllers are neglected in this description, including but not limited to power supply, memory, and circuit details, as these are easily implemented in a variety of ways by one skilled in the art of digital electronic design. The microprocessor utilizes a stored program of instructions to accomplish the calculations described herein. This stored program is assumed to reside within the microprocessor itself, for purposes of this discussion, but an alternate implementation may select a microprocessor which utilizes external memory for the stored program. Note that the timing measurement device referred to in the claims is implemented in the preferred embodiment of the invention via the microprocessor clock, which is the time reference, and the stored program of instructions which use that clock to create a time reference. Thus the timing measurement device is not shown explicitly in the drawings, but its function is a part of the data processing device.

Referring to the input circuitry on the left side of FIG. 5, angle conditioning circuit 501 receives the angle signal from angle measurement device 305 via encoder harness 308 and conditions it to make it accessible to the microprocessor 502. Similarly, strain conditioning circuit 503 receives the strain signal from strain measurement device 310 via strain gauge harness 312. Tow rope length selector 504 comprises a selector switch set by the user to indicate the tow rope length currently used. Tow rope length and present angle are used by the microprocessor to calculate the skier position relative to the boat utilizing a stored program contained within microprocessor 502. Boat speed selector 505, in the preferred embodiment, is a rotary selector switch, similar to tow rope length selector 504. However, this could alternately be implemented as an electrical input from a commercially available boat speed controller, if the boat is equipped with such a device and a suitable interface is available. Skier position, together with boat speed, is used by the microprocessor to determine the skiers progress through the slalom course. Course reference input 506 is an optional input. Some slalom courses, in particular those set up for automatic boat speed control, utilize a device on one of the skier's starting gate buoys 106, which the boat drives through, to signal a sensor on the boat when the boat passes through the starting and final gates. This is currently used to monitor the boat speed throughout the slalom course. If this signal is available, this input is optionally used to indicate to the microprocessor that the start of the slalom course has been reached by the boat. If this input is not used or not available, the course start may be indicated by the skier remaining off to one side of the boat for an extended period of time, or via an additional switch input activated by someone in the boat. Zero adjustment device 507 is used to compensate for installation angle variations. With the skier in position directly behind the boat, zero adjustment device 507, implemented as a momentary contact switch, is depressed to indicate to the microprocessor the angle associated with the centerline of the boat, the reference from which the skier position is derived. Lean adjustment device 508 is implemented in the preferred embodiment as a potentiometer which can be rotated to adjust the amount of skier lean that is allowed for in the microprocessor evaluation of the skier's success in rounding the buoy. When rounding the course buoys 101, a proficient slalom skier will be leaning in towards the course centerline such that his ski is further from the course centerline than his hands. Thus the tow rope handle need not round the buoy for the skier to successfully round the buoy. A skier who leans more will not require the tow rope handle to be as far off to the side in order to ski around the buoy. Real-time clock 509 makes date and time available to the microprocessor in order to label stored course run data. Microprocessor clock 510 provides a time measurement device to the microprocessor to enable measurement of course traversal time.

Now referring to the output circuitry on the right side of FIG. 5, position signal driver 511 and timing signal driver 512 are outputs to enable features in the data reporting device to be described below. These signals are transmitted via position harness 517 and timing harness 518, respectively. Datalink 513 is a serial link connection suitable for connection to a microcomputer or a modem. In the preferred embodiment, this is an industry standard RS-232 datalink, commonly used for microcomputer to modem connections, but it could equally well be implemented to utilize some other type of datalink, including universal serial bus (USB). Through datalink 513, course run data which has been saved over multiple runs may be transmitted to a computer for analysis and presentation. Alternately, through datalink 513 course run data may be transmitted via a modem/wireless phone link to a remote computer while the skier is skiing, allowing real-time remote monitoring of skier progress.

Optional keypad 514, illustrated at the bottom of FIG. 5, comprises switch inputs 515 and display device 516. Switch inputs 515 are implemented as sealed membrane switches in the preferred embodiment, while display device 516 is implemented as a two-line liquid crystal display (LCD). Keypad 514 may be used to replace tow rope length selector 504 or boat speed selector 505 if desired. It may also be used to input skiers initials to tag stored run data in memory. Display device 516 may be used to show course segment times for previous runs, for in-boat analysis of skiing performance.

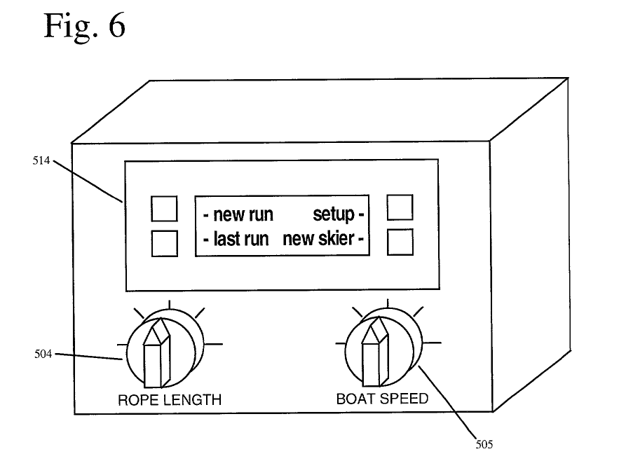

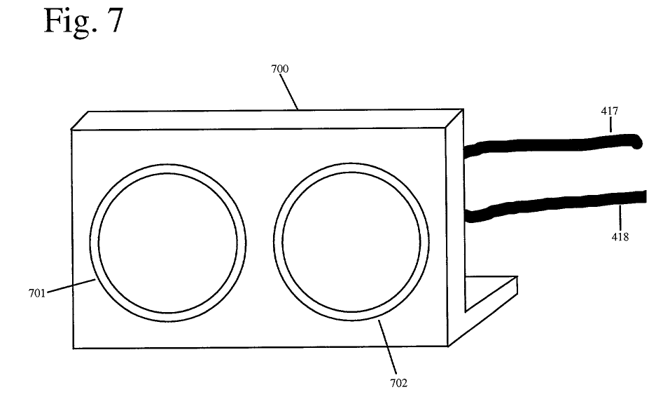

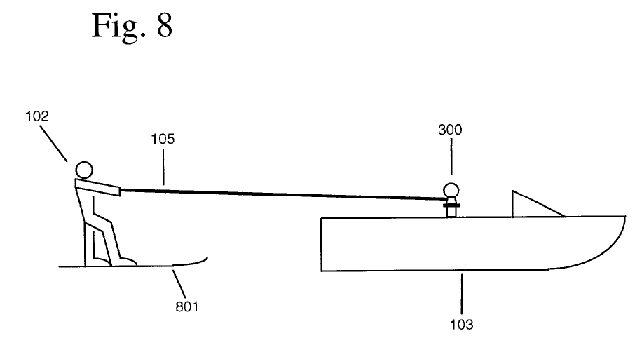

FIG. 6 is an illustration of the controller housing, showing tow rope length selector 504, boat speed selector 505, and keypad 514. Harness connections must be made to this box from angle measurement device, strain measurement device, and data reporting device. Harness connections are not shown in FIG. 6.

The data reporting device is illustrated in FIG. 7. Position lamp 701 and timing lamp 702 are mounted in bracket 603. In the preferred embodiment, each of these is implemented as a sealed brake lamp module as used in trucks. This gives brightness suitable for daylight visibility. Bracket 700 is suitable for mounting in the boat, in view of the skier. In the preferred embodiment, bracket 700 may be mounted on top of bracket 306, allowing the lamps to be placed above the pylon. Position lamp 701 is controlled by position signal driver 511 via position harness 517. Similarly, timing lamp 702 is controlled by timing signal driver 512 via timing harness 518. Position lamp 701 is turned on whenever the skier is far enough from the boat to be outside of the skier buoys. Timing lamp 702 is turned on whenever the skier has reached buoy angle before the skier has progressed beyond the buoy, as inferred from the setting of boat speed selector 505.

Having described the constructional features of the present invention, various modes of use will next be presented. These modes provide the benefits described in the scenarios of the Invention Description section above.

The water-ski performance measuring device of the present invention may be used as an Open-Water Slalom Trainer. Position lamp 701 and timing lamp 702 are used as indications to the practicing intermediate skier, not using a slalom course, that both distance from the boat and time spent traversing the wake are adequate to complete a slalom course.

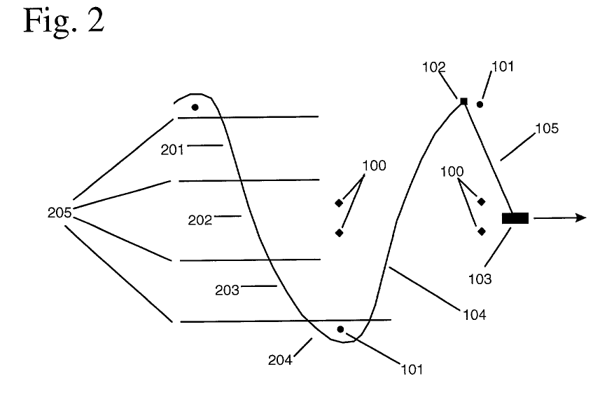

The water-ski performance measuring device of the present invention may be used as a Slalom Trainer with Run Statistics. For skiers practicing on a slalom course, the present invention can provide detailed statistics on their performance. Each turn is broken down into a number of segments, where segments is defined in this context to mean regions of distance from the center line of the course, as illustrated in FIG. 2 and described previously. Each segment would correspond to a range of tow rope angles at a given tow rope length. The time spent in each segment is a measure of performance for that segment. Furthermore, the tow rope strain in each segment is a measure of performance for that segment. Following a run, keypad 514 may be used to scroll through the data for each segment of each turn in a course run. In addition, the time margin for each buoy may be displayed. The time margin is defined as the time between the skier reaching a width which would allow passing around the buoy and the time at which the skier passes the buoy. Averages and trends for each number may be shown, as well as comparisons between left and right side performance. Each run's data can be tagged with the skier's initials, date, and time, stored in local memory, and later uploaded to a microcomputer for storage and analysis. This makes an unprecedented level of data available to the training slalom skier.

The water-ski performance measuring device of the present invention may be used as a Slalom Trainer with Broadcast. Through use of datalink 513, coupled to a cellular phone and modem combination, angle, strain, and time data for the course can be uploaded instantly to a remote computer. This allows the run statistics of the previous paragraph to be available to remote observers, for such purposes as television commentary.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

What is claimed is:

1. A water-ski performance measuring apparatus that determines a position of a water-skier relative to a boat, wherein the water-skier holds onto a rope extending from the boat, said performance measuring device comprising:
angle measurement device that measures an angular displacement over time of a rope extending from a boat, wherein the angular displacement is measured from a predetermined centerline; and
a controller that correlates the measured angular displacement of the rope with a position of the boat.

2. The water-ski performance measuring apparatus as recited in claim 1, further wherein said controller includes an adjustment means for calibrating the apparatus for various tow rope lengths and boat speeds.

3. The water-ski performance measuring apparatus as recited in claim 1, wherein said controller further controls an indication means for indicating success of skier in rounding buoys fast enough.

4. The water-ski performance measuring apparatus as recited in claim 1, further including a storage means for storing the measured angular displacement and correlation between angular displacement and boat position.

5. The water-ski performance measuring apparatus as recited in claim 1, wherein said controller includes an output for transferring the correlations between angular displacement and boat position to an external receiver.

6. The water-ski performance measuring apparatus as recited in claim 1, further including a strain measurement means for measurement of tension on tow rope.

7. A method of evaluating slalom water-ski performance by measuring the angle or the tension or both in the slalom tow rope and from those measurements calculating a few numbers which characterize the skiers performance.

8. The method of claim 7 wherein the calculated numbers are the times spent by the skier in various segments of the slalom run, where segments are defined as regions of distance from the center of the slalom course.

9. The method of claim 7 wherein the calculated numbers are the times between the skier reaching a width which would allow passing around the buoy and the time at which the skier passes the buoy.

10. The method of claim 7 wherein the calculated numbers are the tensions on the slalom tow rope in various segments of the slalom run, where segments are defined as regions of distance from the center of the slalom course.
